(19) United States
(12) Patent Application Publication
(10) Pub. No.: US 2010/0111302 A1
(43) Pub. Date: May 6, 2010

(54) DIGITAL SIGNAL PROCESSING METHOD AN SYSTEM EMPLOYING SUCH METHOD

(75) Inventors: Mauro Hermes Veliano Antonetti, Rome (IT); Angelo Patrizi, Rome (IT)

Correspondence Address: ROBERTS MLOTKOWSKI SAFRAN & COLE, P.C.;Intellectual Property Department, P.O. Box 10064, MCLEAN, VA, 22102-8064, US

(73) Assignee: TELECOMPONENTI S.r.l., Rome (IT)

(21) Appl. No.: 12/522,662

(22) PCT Filed: Dec. 20, 2007
(86) PCT No.: PCT/IT07/00899

§ 371 Date: Jan. 15, 2010

(30) Foreign Application Priority Data
Jan. 9, 2007 (IT) RM2007A000010

(51) Int. Cl. H04L 27/00; G06F 12/00; H04L 9/00; H04B 1/38

(52) U.S. Cl. 380/255; 711/102; 375/295; 375/219; 711/E12.001

(57) ABSTRACT

The present invention relates to a method for transmission of a digital signal from a first unit (2), operating according to a transmission mode, to a second unit (3), operating according to a reception mode, through a transmission channel (4), said first unit carrying out the following steps: (a) division of said digital signal in data blocks, each data block comprising n elementary units each having a set time duration: and (b) permutation of elementary unit order of each block on the basis of a permutation instruction, said permutation instruction being selected from a permutation instruction table calculated beforehand, by generation of an address by a pseudo-random address generator (11) by a synchronism seed (12); and said second unit (3) carrying out the following step: (c) permutation of order of said elementary units of each data block received on the basis of a permutation instruction corresponding to the permutation instruction applied to each one of said data blocks during said step (b) from said first unit (2), said permutation instruction being selected from a permutation instruction table calculated beforehand corresponding to the table contained in said first unit (2), following the generation of an address by a pseudo-random address generator (11) by the synchrony seed (12) corresponding to the synchrony seed (12) used by said pseudo-random address generator (11). The present invention also relates for a system (1) for carrying out said method.

The present invention relates to a digital signal processing method and system employing such method.

More specifically, the invention concerns a method for processing digital data particularly arriving from analog sources that can be interpreted by human beings or intelligible (e.g. sound sources or video sources) permitting safe transmission within serial channels not necessarily having a “loss less” type code, i.e. without loss of information.

As it is well known, at present, very large amount of audio and/or video data are transmitted by communication net. Further, it is always more tangible the risk of interception of said data for different reasons, among which industrial espionage.

Automatic systems are presently available for protection of informatic data. Particularly, cryptography systems are known since many times for digital data sources. Methods on which said systems are based are usually employed for transmission of data through the communication net and they need a transmission channel ensuring identity if data between source and destination, in order to permit an exact reconstruction of the same.

Mobile telephone channels, such as GSM (Global System for Mobile Communications) can transmit a constant or variable bit rate (i.e. amount of bit transferred from an entity to another one for coded on in a set format), but coded on systems employed in said channels are of the “lossy” type, I.e. they are characterised by a degradation of signal, i.e. a loss of information.

Thus, conventional cryptography processes cannot be employed for processing and transmitting audio and/or analog data through the above telephone channels.

In other words, it makes it impossible validation by a known automatic device or procedure.

It is well evident that possibility of making safe transmission of audio and/or video data through communication channels is a necessity, even taking into consideration the increasing amount, quality and importance of transmitted data.

In view of the above, it is object of the present invention suggesting a method for safe transmission of sampled signals from sources that can be interpreted by human beings or intelligible analog sources, preferably a real time transmission, between peripheral positions placed in geographically different places through a serial type data channel not permitting ensuring identity of information transported, but only its intelligibility.

It is further object of the present invention that of suggesting a system permitting carrying out the above method.

It is therefore specific object of the present invention a method for transmission of a digital signal from a first unit, operating according to a transmission mode, to a second unit, operating according to a reception mode, through a transmission channel, said first unit carrying out the following steps:

(a) division of said digital signal in data blocks, each data block comprising n elementary units each having a set time duration; and

(b) permutation of elementary unit order of each block on the basis of a permutation instruction, said permutation instruction being selected from a permutation instruction table calculated beforehand, by generation of an address by a pseudo-random address generator by a synchronism seed;

and said second unit carrying out the following step:

(c) permutation of order of said elementary units of each data block received on the basis of a permutation instruction corresponding to the permutation instruction applied to each one of said data blocks during said step (b) from said unit, said permutation instruction being selected from a permutation instruction table calculated beforehand corresponding to the table contained in said unit, following the generation of an address by a pseudo-random address generator by the synchrony seed corresponding to the synchrony seed used by said pseudo-random address generator.

Always according to the invention, said tables comprise m permutation instructions calculated beforehand.

Still according to the invention, said tables are respectively memorised within a memory of said first and second units.

Advantageously according to the invention said memory is a ROM (Read Only Memory) memory.

Furthermore according to the invention, addresses generated by said pseudo-random address generators have a bit length equal to that of each one of the m 2 based logarithm integer majorant.

Always according to the invention, said random address generators can be cryptographically safe.

Still according to the invention, said method can comprise, before step (a), the following step:
obtaining pre-set synchrony seed.

Furthermore according to the invention, said synchrony seed can be set beforehand in said first and second units.

Advantageously according to the invention, said synchrony seed can be negotiated through said channel.

Preferably, according to the invention, each data block, before permutation of relevant elementary units in said first and second units can be stored within a buffer memory.

Always according to the invention, said digital signal can be the result of sampling and transformation of an analog signal.

Still according to the invention, sampling of said analog signal during said step can occur under a PCM (Pulse Code Modulation) mode.

Furthermore, according to the invention, said transmission channel can be a bi-directional channel.

Advantageously according to the invention, said transmission channel can provide a variable bit-rate coded on.

Always according to the invention, said transmission channel can be the GSM (Global System for Mobile Communication) voice channel.

Still according to the invention, said transmission channel can provide a fixed bit rate coded on.

Furthermore according to the invention, after said step (c), said digital signal can be transformed into an analog signal by a digital-analog data converter.

Preferably, according to the invention, n=16, m=2048, address generated by said pseudo-random address generator ≧11 bits and time length of said elementary units can be of 20 milliseconds.

It is further object of the present invention a system for carrying out the above method, comprising a first digital signal transceiving unit, a digital signal second transceiving unit, suitable to interact with said first transceiving unit, said first and second transceiving units being suitable independently operating under a transmission and reception mode, and a communication channel, to which said first and second transceiving units are connected, through said communication channel, passing said digital signal; characterised in that said first and second units comprising each one sampling means suitable to transform in transmission an inlet analog signal into a digital signal to be transmitted, a buffer memory within which said data blocks of said digital signal are sequentially acquired, respectively before transmission and after reception of said signal through/from said channel; a buffer memory read unit; a memory within which a table is stored, said table containing permutation instructions calculated beforehand, by which said read unit permutes order of said elementary units of each block contained within said buffer memory; a pseudo-random address generator apt to generate an address by a seed, by said address said pseudo-random address generator selecting, for each block stored within said buffer memory, a permutation instruction from said table; and digital-analog converter means, apt to transform said digital signal received according to the reception mode into an analog signal.

Always according to the invention, said random address generators can be cryptographically safe.

Still according to the invention said memories can be of the ROM (Read Only Memory) type.

Furthermore, according to the invention, said sampling means can make sampling of said analog signal during said step (a) according to a PCM (Pulse Code Modulation) mode.

Advantageously, according to the invention, said transmission channel can be of the bi-directional types with a “lossy” coded on.

Preferably, according to the invention, said transmission channel can be a GSM (Global System for Mobile Communication) channel.

Always according to the invention, said first and said second units can be installed on a cellular phone and/or can comprise fittings interacting with a cellular phone and/or can be integral part of a cellular phone fittings interacting with said phone and/or that can be installed within a cellular phone.

The present invention will be now described, for illustrative but not limitative purposes, according to its preferred embodiments, with particular reference to the figures of the enclosed drawings, wherein:

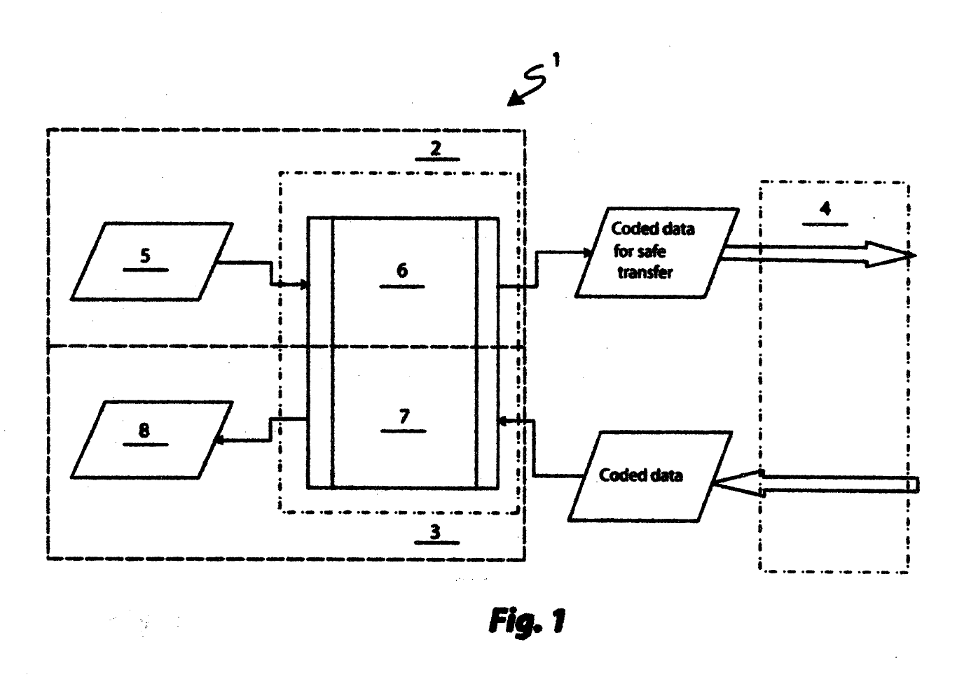

FIG. 1 shows a block diagram of the system apt to carry out a processing method of a digital signal according to the present invention;

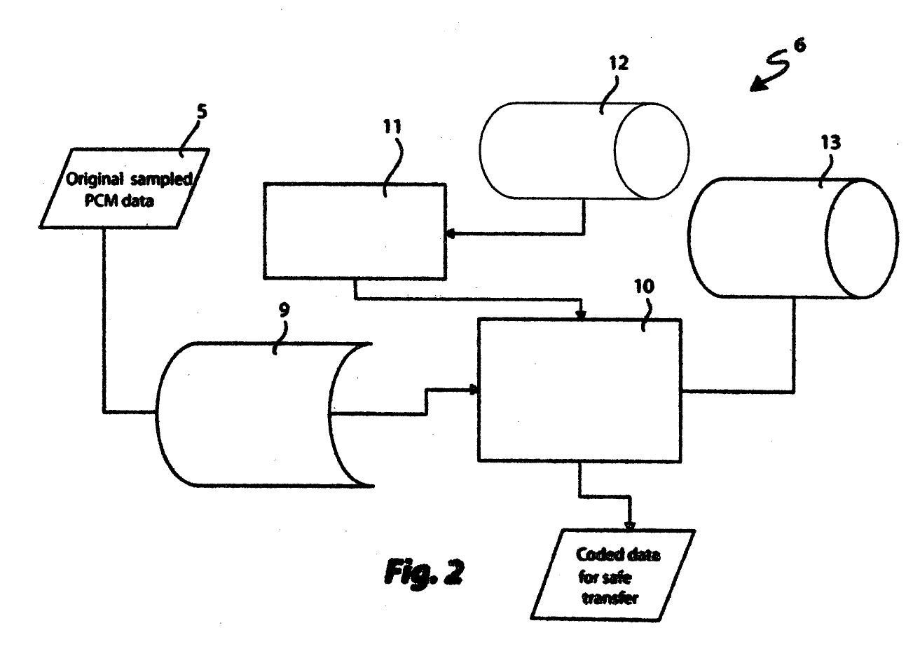

FIG. 2 shows a block diagram of a coded on module of system of FIG. 1;

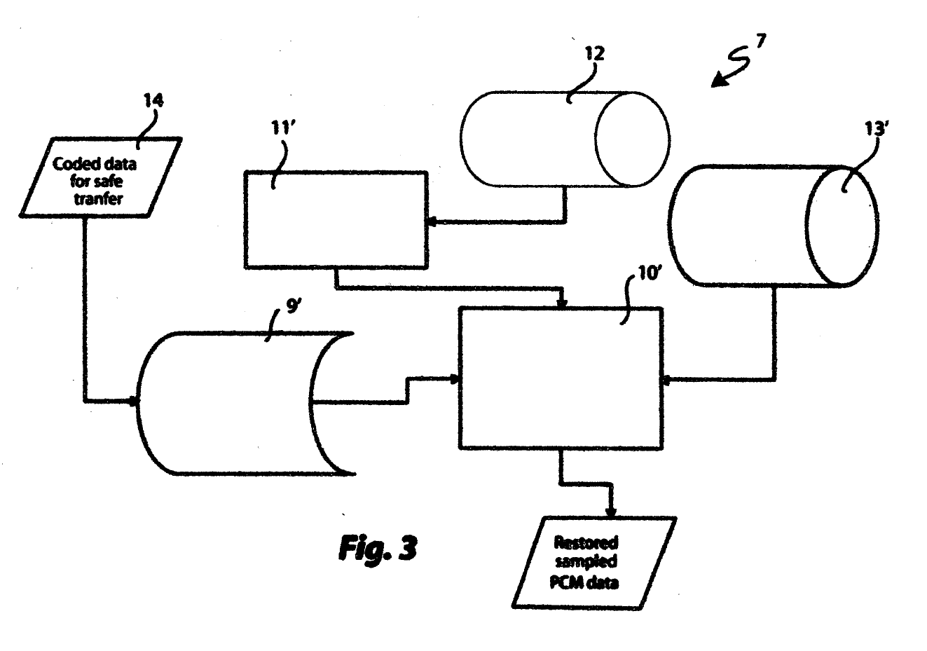

FIG. 3 shows a block diagram of a decoding module of the system according to FIG. 1; and

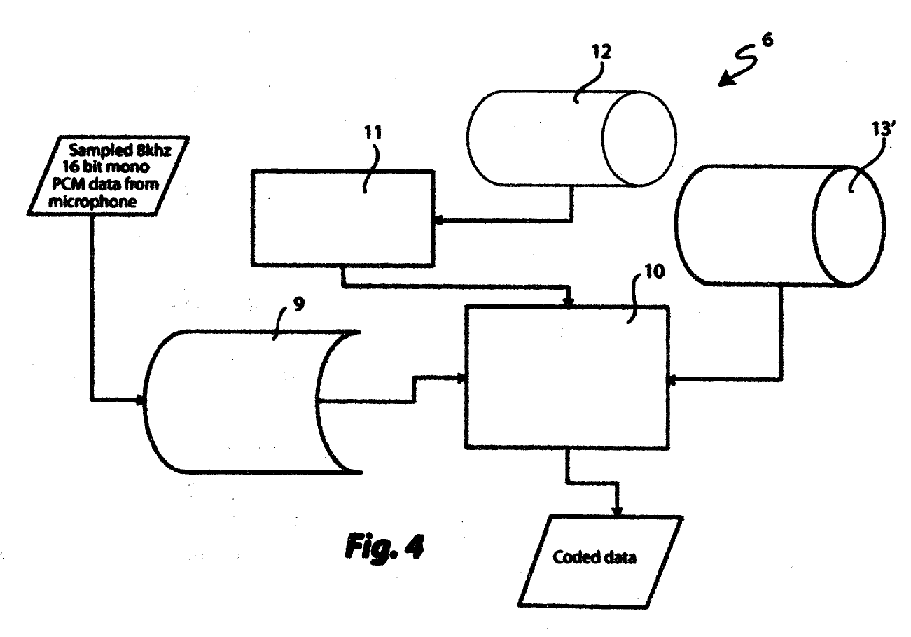

FIG. 4 shows a block diagram of an application of the codifier according to the system of FIG. 1.

Making reference to FIG. 1, it is observed a block diagram of system 1 apt to carry out the safe transmission method of sampled signals from analog sources according to the present invention.

System 1 is mainly comprised of a first unit 2 and of a second unit 3, both suitable operating according to a transceiving mode, connected through a bi-directional data transmission unit 4 with fixed of variable bit rate coded on.

A data sampling unit 5 is present within said first unit 2, connected to a coded on module 6.

Second unit 3 comprises a decoding module 7 connected to a digital-analog data converter module 8 (DAC—Digital to Analog Converter).

It must be taken into consideration that, as already mentioned, units 2 or 3 can be comprised so as to independently operate according to a transmission and reception mod, being communication channel 4 a bi-directional channel. In the following, said first unit 2 will operate according to a transmission mode and said second unit 3 will operate according to a reception mode.

FIG. 2 shows block diagram of coded on module 6. It is particularly observed that said coded on module 6 is connected and interfaced with the data sampling unit 5 by a buffer memory 9, connected with a reading unit 10 of said buffer memory 9.

A pseudo-random address generator 11 is connected with said reading unit 10. Said pseudo-random address generator 11 is an n-bits generator (where n is an integer number) and can generate pseudo-random numeral sequences by the use of a seed 12.

Reading unit 10 is further connected to a memory unit 13, preferably a ROM memory, wherein a table of sequences calculated beforehand is stored, the function of which will be explained in the following.

FIG. 3 shows block diagram of decoding module 7 that, as evident, has a structure substantially equivalent to the structure of coded on module 6. In fact, in said figure there are present a buffer memory 9′, reading unit 10′ connected to a random address generator 11′, having n-bits as well, generating pseudo-random numerical sequences, and a memory unit 13′, preferably a ROM memory, wherein the table of sequence calculated beforehand identical to the table stored within memory 13 is stored as well.

System 1 is particularly studied for transmission of analog data on a mobile telecommunication channel, such as the GSM voice channel. It is in fact known that said transmission channel is of the “lossy” type, i.e. transmission occurs by a transmission coded on loosing some information and noisy.

During the transmission from said first unit 2 to said second unit 3, analog signal is first sampled, as it occurs in the known solutions, and transformed into digital signal, in the present embodiment of the PCM (Pulse Code Modulation) type.

Digital data are coded by coded on module 6, transmitted to said second unit 3, decoded by decoding module 7 and converted from digital into analog by data converter module 8.

Considering that system 1 has two operation modes that can be selected alternatively:
transparent or “bypass” mode, activated by default, wherein system 1 is fully compatible with every PCM audio encoder.
protected mode, wherein system talks under a protected mode only with another encoder, after a starting recognition and synchronization (handshaking) step, permitting actuation of safety algorithm according to the invention that will be described in greater detail in the following.

Passage from one mode to the other one is signalled on apparatuses implementing said units 6 and 7, in a way that can be recognised by the user.

In greater detail, the operation steps of system 1 will be described in the following, and at first a compulsory communication step will be carried out, during which the following operation are carried out:
exchange of public keys, suitable to ensure a correct asynchronous coding. Particularly, said first unit 2 sends a public key to said second unit 3.
sending the synchrony seed 12 by said second unit 12, that will be used by relevant inner random generators 11 and 11′ of each one of said first 2 and second 3 units. Said seed 12 is exchanged according to an asynchronous cryptographic mode. Thus, only said first unit 2 can decoding said seed.

Digital signal arriving from said data sampling unit 5 is divided into elementary units with a set time length.

A number n of said elementary units of data sampled according to a PCM mode, comprising a data block, from the data sampling unit 5 are stored first within said buffer memory 9, having a suitable dimension for operation of algorithm.

In case transparent mode is selected, reading unit 10 reads data according to the arrival order within the buffer memory 9. Signal is thus transmitted “without coding”. Obviously, said unit 3 reads also when receiving said elementary units according to the exact arrival order.

In case protected operation mode is selected, cryptographically safe, random address generator 11 generates a series of addresses at n bits according to a pseudo-random mode.

By said addresses, memory 13 permutation sequences are recovered. Each permutation represents reading order by which reading unit 10 reads elementary units from buffer memory 9 of each data block.

Optionally, in order to increase interpretative difficulty of the method employed, address generated can be coded using a symmetric coding algorithm.

Exit is send through digital interface as fixed bit rate PCM audio data.

Operation of unit 3 according to protected reception mode is substantially inverted. Particularly, coded data 14 arriving from unit 2 are collected within data blocks of n elementary units. Each block of elementary Units corresponds to those sent. Obviously, each block contains permutated n elementary units.

Thus, each block of n elementary units is stored according to a sequence within the buffer memory 9′.

Seed 12 is the same seed employed for coded on module 7. Thus, random address generator 11′, which is cryptographically safe, generates in synchronism a series of n bits addresses corresponding to those generated by random address generator 11 of unit 2.

In other words, each one of said addresses corresponds to those generated by the random address generator 11 of unit 2 by which permutations blocks of n elementary units are generated by the transmission signal.

By said address series, it is obtained a sequence of permutations for each block from memory 13′, corresponding to the one obtained from memory 13 of transmission unit 2.

By every permutation obtained, it is possible recovering reading order of the corresponding block of data elementary unit.

Also in this case in order to increase interpretative difficulty of the method employed, generated address can be coded using a symmetric coding algorithm.

Digital exit is converted by said digital-analog data converter module 8 into an analog signal.

It is observed that, even if compression or noise generated by channel have caused losses of the signal information, reconstructed signal is intelligible and audio information (e.g. voice) preserved.

Minimum dimension of said elementary entities is proper of the data transmission channel 4 coded on. Particularly, for GSM coded on a minimum dimension of 20 msec will exist.

FIG. 4 shows an application of the present invention in coded on module 6, that can be applied to transmission of a microphone audio signal in a GSM type channel 4.

Seed 12, synchronized with coded on module is a 64 bits seed; random generator 11 is a 11 bits generator, that can select M=2¹¹=2048 sequences calculated beforehand of table stored within memory 13; number of blocks read by buffer memory 9 is n=16; and elementary units last 20 milliseconds.

Therefore, a data block has a time duration of 0.32 seconds.

Data arriving from data sampling unit 5 are sampled at 8 kHz at 16 bits, and arrive from an analog source, particularly the microphone of a cellular phone.

As already said, above method is efficient only if used on data originated by analog sources that can be interpreted by human beings, e.g. audio and video data. In fact, algorithm does not ensures identity of final data with respect to the original one, but only its intelligibility.

System bases its efficiency about certainty of high computational complexity necessary for decoding of a single intercepted date all along the transfer step among peripheral units. Said complexity is obtained generating continuous permutations in sampled audio data blocks, using a suitable algorithm to ensure variability of sequences, cryptographic safety and synchrony between the two peripheral units.

Above system, as any other audio encoder, is provided with analog inlets and outlets for taking and hearing samples, and with digital inlets and outlets, necessary for communication interface.

On the basis of the above specification, it can be noted that basic feature of the present invention is that of generating continuous permutations of elementary units of the transmission means, suitable to ensure not intelligibility of the same samples during their transmission. Said permutations can be obtained by every method suitable to ensure variable and evenly distributed sequences.

An advantage of the present invention is that of creating a high complexity of reconstructing the signal. Said complexity is obtained generating continuous permutations of sampled audio data blocks, using a suitable algorithm ensuring sequence variability, cryptographic safety and synchrony between the two peripheral units.

A further advantage of the present invention is that of permitting transmission of signals through “lossy” signals, thus preserving intelligibility of the received signal.

The present invention has been described for illustrative but not limitative purposes, according to its preferred embodiments, but it is to be understood that modifications and/or changes can be introduced by those skilled in the art without departing from the relevant scope as defined in the enclosed claims.

1. Method for transmission of a digital signal from a first unit (2), operating according to a transmission mode, to a second unit (3), operating according to a reception mode, through a transmission channel (4), said first unit carrying out the following steps:
(a) division of said digital signal in data blocks, each data block comprising n elementary units each having a set time duration; and
(b) permutation of elementary unit order of each block on the basis of a permutation instruction, said permutation instruction being selected from a permutation instruction table calculated beforehand, by generation of an address by a pseudo-random address generator (11) by a synchronism seed (12);
and said second unit (3) carrying out the following step:
(c) permutation of order of said elementary units of each data block received on the basis of a permutation instruction corresponding to the permutation instruction applied to each one of said data blocks during said step (b) from said first unit (2), said permutation instruction being selected from a permutation instruction table calculated beforehand corresponding to the table contained in said first unit (2), following the generation of an address by a pseudo-random address generator (11) by the synchrony seed (12) corresponding to the synchrony seed (12) used by said pseudo-random address generator (11).

2. Method according to claim 1, characterised in that said tables comprise m permutation instructions calculated beforehand.

3. Method according to one of the preceding claims, characterised in that said tables are respectively memorised within a memory of said first (2) and second (3) units.

4. Method according to claim 3, characterised in that said memory (13, 13′) is a ROM (Read Only Memory) memory.

5. Method according to one of the preceding claims, characterised in that, addresses generated by said pseudo-random address generators (11, 11′) have a bit length equal to that of each one of the m 2 based logarithm integer majorant .

6. Method according to one of the preceding claims, characterised in that said random address generators (11, 11′) are cryptographically safe.

7. Method according to one of the preceding claims, characterised in that it comprises, before step (a), the following step:
obtaining pre-set synchrony seed (12).

8. Method according to claim 7, characterised in that said synchrony seed (12) is set beforehand in said first and second units (2, 3).

9. Method according to claim 7, characterised in that said synchrony seed (12) is negotiated through said channel (4).

10. Method according to one of the preceding claims, characterised in that each data block, before permutation of relevant elementary units in said first (2)) unit are stored within a buffer memory (9).

11. Method according to one of the preceding claims, characterised in that each data block, before permutation of relevant elementary units in said second (3) unit are stored within a buffer memory (9).

12. Method according to one of the preceding claims, characterised in that said digital signal are the result of sampling and transformation of an analog signal.

13. Method according to claim 11, characterised in that sampling of said analog signal during said step occurs according to a PCM (Pulse Code Modulation) mode.

14. Method according to one of the preceding claims, characterised in that said transmission channel is a bi-directional channel.

15. Method according to one of the preceding claims, characterised in that said transmission channel (4) provides a variable bit-rate coded on.

16. Method according to claim 12, characterised in that said transmission channel is the GSM (Global System for Mobile Communication) voice channel.

17. Method according to one of the preceding claims 1-13, characterised in that said transmission channel (4) provides a fixed bit rate coded on.

18. Method according to one of the preceding claims, characterised in that after said step (c), said digital signal can be transformed into an analog signal by a digital-analog data converter (8).

19. Method according to one of the preceding claims, characterised in that n=16, m=2048, address generated by said pseudo-random address generator ≧11 bits.

20. Method according to one of the preceding claims, characterised in that time length of said elementary units is of 20 milliseconds.

21. System (1) for carrying out the method according to claims 1-20, comprising a first digital signal transceiving unit (2), a digital signal second transceiving unit (3), suitable to interact with said first transceiving unit (2), said first and second transceiving units (2, 3) being suitable independently operating under a transmission and reception mode, and a communication channel (4), to which said first (2) and second (3) transceiving units are connected, through said communication channel (4), passing said digital signal; characterised in that said first and second units (2, 3) comprise each one sampling means (5) suitable to transform in transmission an inlet analog signal into a digital signal to be transmitted, a buffer memory (9, 9′) within which said data blocks of said digital signal are sequentially acquired, respectively before transmission and after reception of said signal through/from said channel (4); a buffer memory (9, 9′) read unit (10, 10′); a memory (13, 13′) within which a table is stored, said table containing permutation instructions calculated beforehand, by which said read unit (10, 10′) permutes order of said elementary units of each block contained within said buffer memory (9, 9′); a pseudo-random address generator (11, 11′) apt to generate an address by a seed (12), by said address said pseudo-random address generator (11, 11′) selecting, for each block stored within said buffer memory (9, 9′), a permutation instruction from said table; and digital-analog converter means (8), apt to transform said digital signal received according to the reception mode into an analog signal.

22. System (1) according to claim 21 characterised in that said random address generators (11, 11′) is cryptographically safe.

23. System (1) according to one of the preceding claims 21-22, characterised in that said memories (13, 13′) are of the ROM (Read Only Memory) type.

24. System (1) according to one of the preceding claims 21-23, characterised in that said sampling means make sampling of said analog signal during said step (a) according to a PCM (Pulse Code Modulation) mode.

25. System (1) according to one of the preceding claims 21-24, characterised in that said transmission channel (4) is of the bi-directional types with a “lossy” coded on.

26. System (1) according to one of the preceding claims 21-25, characterised in that said transmission channel (4) is a GSM (Global System for Mobile Communication) channel.

27. System (1) according to one of the preceding claims 21-26, characterised in that said first and said second units (2, 3) are installed on a cellular phone and/or comprise fittings interacting with a cellular phone and/or can be integral part of a cellular phone fittings interacting with said phone and/or that can be installed within a cellular phone.

28. Method and system (1) according to each one of the preceding claims, substantially as illustrated and described.
